(19) United States
(12) Patent Application Publication
(10) Pub. No.: US 2024/0326295 A1
(43) Pub. Date: Oct. 3, 2024

(54) WASTE CURING DEVICE AND METHOD OF USE

(71) Applicant: Zewski Corporation, Magnolia, TX (US)

(72) Inventors: Spencer Brian WONG, Boston, MA (US); Emiliano MORA, JR., New York, NY (US); Misael ORTIZ, Winter Haven, FL (US); Colin Christopher EDWARDS, Far Hills, NJ (US); Kimberly RODRIGUEZ PARILLI, The Woodlands, TX (US); Jae Hyen KIM, Seoul (KR); Theodore Elliott HOISINGTON, Houston, TX (US); Lawrence KILISZEWSKI, The Woodlands, TX (US)

(21) Appl. No.: 18/191,575

(22) Filed: Mar. 28, 2023

(51) Int. Cl. B29B 9/16; B33Y 10/00

(52) U.S. Cl. CPC B29B 9/16; B33Y 10/00; B29B 2009/168; B29B 2017/0217

(57) ABSTRACT

In a waste curing device for curing uncured waste resin from a manufacturing process, a waste hopper receives the uncured waste resin. A metered discharge valve is connected to the waste hopper to receive the uncured waste resin and to output a metered stream of waste resin. A curing container is configured to hold surfactant fluid and to receive the metered stream of waste resin into the surfactant fluid such that the surfactant fluid disperses the stream of waste resin as discrete droplets of waste resin. A curing system is configured to cure the droplets of waste in the curing container to form cured waste pellets. Uncured waste resin from a 3D printing process can be collected and cured into pellets onsite.

### FIELD

This disclosure generally pertains to a waste curing device and methods of disposing of uncured resin waste byproducts of manufacturing.

### BACKGROUND

Certain 3D printers use UV-curable resin. The nozzle of the printer is regularly cleaned to remove any uncured resin and resin residue. After a print job or whenever print material is changed, the uncured waste resin is removed from the nozzle. Hence, uncured waste resin is a byproduct of normal operation and maintenance of a 3D printer. The uncured waste resin is considered hazardous industrial waste and thus is stored, for safety and environmental reasons, in a leak-proof container. The uncured waste resin cannot be disposed of as ordinary trash because of its hazardous nature.

### SUMMARY

In one aspect, a waste curing device for curing uncured waste resin from a manufacturing process comprises a waste hopper adapted to receive the uncured waste resin. A metered discharge valve is connected to the waste hopper to receive the uncured waste resin and to output a metered stream of waste resin. A curing container is configured to hold surfactant fluid and to receive the metered stream of waste resin into the surfactant fluid such that the surfactant fluid disperses the stream of waste resin as discrete droplets of waste resin. A curing system is configured to cure the droplets of waste in the curing container to form cured waste pellets.

In another aspect, a method of disposing of uncured waste resin from a 3D printing process comprises collecting the uncured waste resin at a site of one or more 3D printers used in the 3D printing process and curing the collected uncured waste resin into pellets at the site.

Other aspects and features will be in part apparent and in part pointed out hereinafter.

### BRIEF DESCRIPTION OF THE DRAWINGS

FIG. 1 is a fragmentary perspective of a waste curing device according to the present disclosure, showing the device in a state where it is loaded with uncured waste and inactive;

FIG. 2 is perspective of the waste curing device, wherein a door to a hopper chamber is open and uncured waste resin is being poured into a hopper;

FIG. 3 is a fragmentary perspective similar to FIG. 1, showing a hand pressing a button to activate a curing cycle;

FIG. 4 is a fragmentary perspective similar to FIG. 1, showing the device during a curing cycle;

FIG. 5 is a fragmentary perspective similar to FIG. 1, showing the device after a curing cycle;

FIG. 6 is a perspective of the curing device, wherein a door to a curing chamber is open and a curing container containing cured waste is removed from the device on a cart;

FIG. 7 is a perspective similar to FIG. 6, but showing an alternative embodiment where the cart is replaced by a slide-out platform; and

FIG. 8 is a perspective similar to FIG. 6, showing a hand lifting a pellet filter from the curing container to remove cured pellets of waste resin.

Corresponding parts are given corresponding reference characters throughout the drawings.

### DETAILED DESCRIPTION

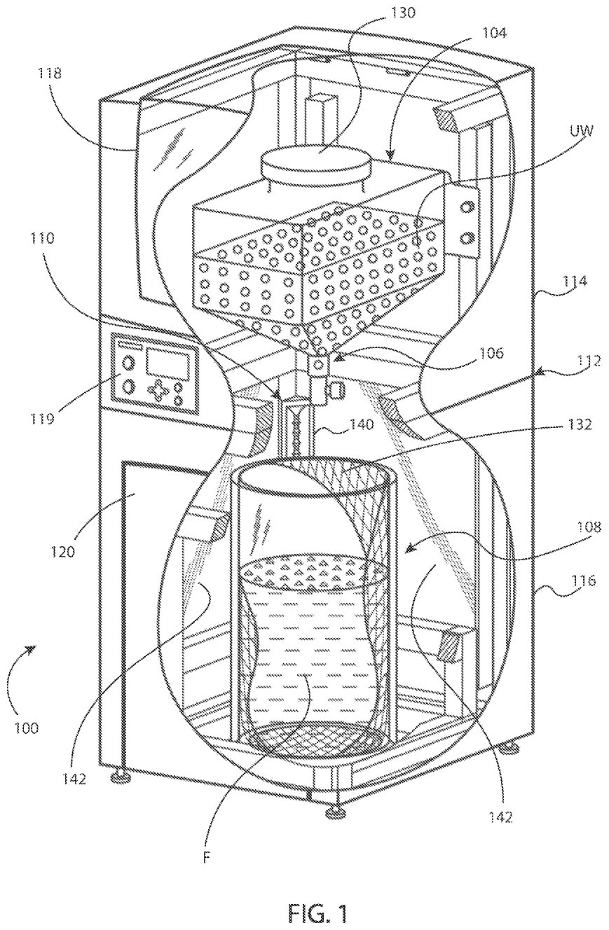

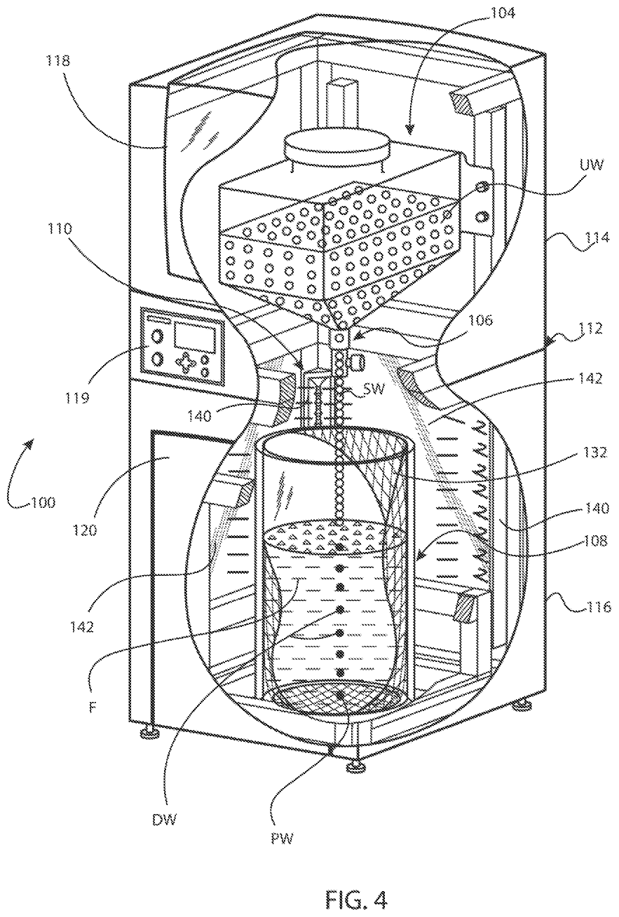

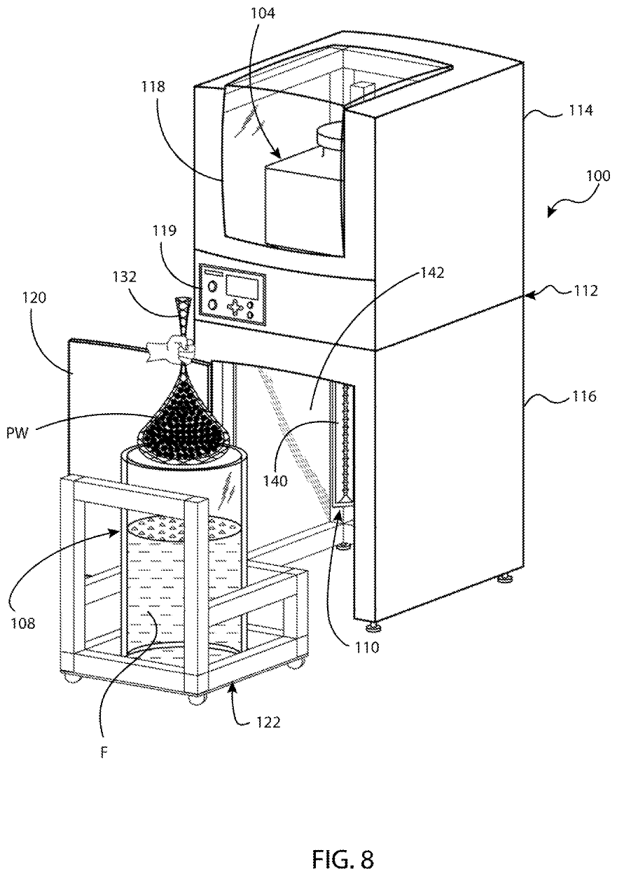

Referring to FIGS. 1-8, an exemplary embodiment of a waste curing device for curing uncured waste resin from a 3D printing process (broadly, uncured waste from a manufacturing process) is generally indicated at reference number 100. In this disclosure, “uncured” encompasses liquid resin and resin material that is partially but not fully cured. As will be explained in further detail below, the device 100 is configured to receive a volume of hazardous, uncured waste resin UW and form the material into safe, cured pellets PW (FIG. 8). In general, the waste curing device 100 comprises a waste hopper 104, a metered discharge valve 106, a curing container 108, and a curing system 110. As will be explained in further detail below, the waste hopper 104 is configured to receive uncured waste resin UW, and the metered discharge valve 106 is configured to output a metered stream SW (FIG. 4) of the uncured waste resin into the curing container 108. The curing container 108 is configured to hold surfactant fluid F that disperses the waste resin as droplets DW. As the droplets DW sink, the curing system 110 cures the droplets to form fully cured pellets that can be recycled, put to direct use, or disposed of as normal, non-hazardous trash.

In the illustrated embodiment, the waste curing device 100 comprises a two-part housing 112 that holds the above-described components. The housing 112 is preferably opaque to ultraviolet (UV) light to contain UV light emitted by the curing system 110. The housing 112 includes an upper hopper chamber 114 and a lower curing chamber 116. The hopper chamber 114 includes an access door 118 that can be selectively opened to provide access to the hopper 104 for filling with uncured waste resin UW. Suitably the access door 118 seals the hopper chamber 114 to prevent leakage of the hazardous waste resin in the event of a spill. In one embodiment, the access door 118 is at least partially formed from a UV-opaque window so that an operator can monitor the curing process.

A control panel 119 for interacting with a device controller (not shown) is mounted on the housing 112 below the access door 118. The control panel 119 includes one or more inputs for controlling the curing process and an indicator or display for presenting information to the user about the curing process.

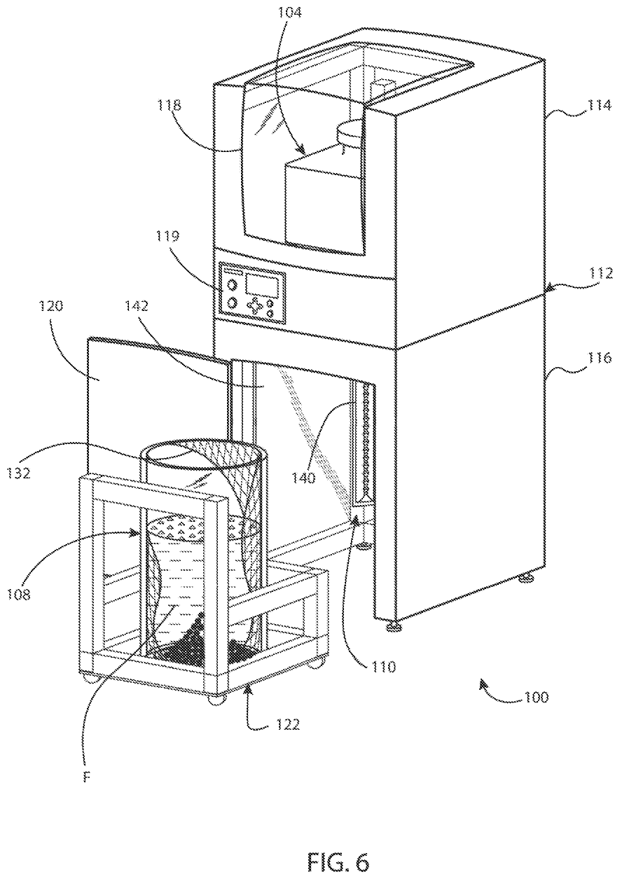

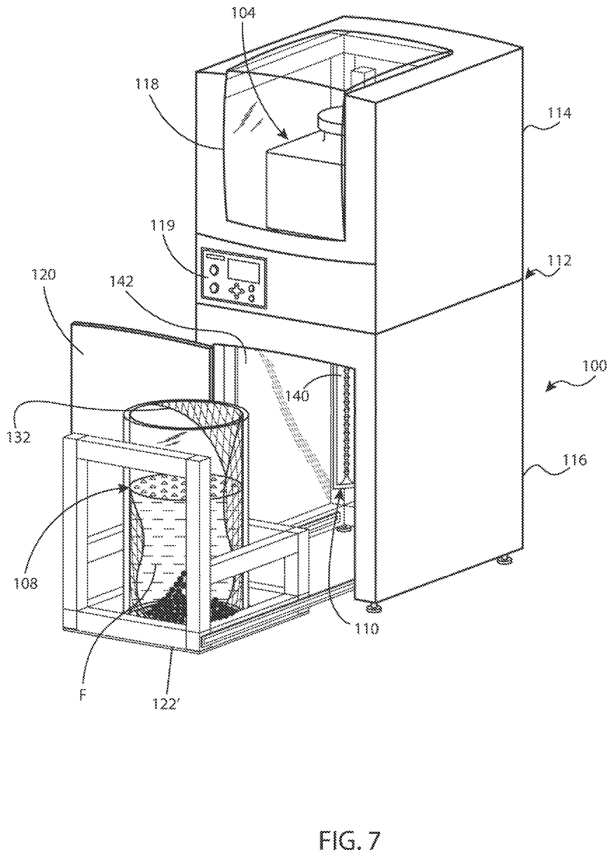

The curing chamber 116 is configured to contain the curing container 108 and curing system 110. The curing chamber 116 comprises an access door 120 through which the curing container can pass into and out of the curing chamber. Suitably, the curing chamber 116 comprises a container carriage 122 that carries the curing container into and out of the chamber. In one embodiment shown in FIG. 6, the container carriage 122 comprises a cart that rolls on the ground and is entirely removable from the curing chamber 116. In another embodiment shown in FIG. 7, the container carriage 122′ comprises a slide-out platform connected to the curing chamber 116 by drawer slides.

The waste hopper 104 has a top end and a bottom end spaced apart along a height. The top end defines an inlet opening that can be selectively covered by a lid 130. The bottom end of the waste hopper 104 defines an outlet opening operatively connected to the metered discharge valve 106. The bottom portion of the hopper 104 tapers toward the outlet opening so that all uncured waste resin UW in the hopper can be directed through the outlet opening to the metered discharge valve 106.

The metered discharge valve 106 is configured to output a metered stream of waste SW into the curing container 108. In one or more embodiments, the metered discharge valve 106 is a solenoid-controlled valve (broadly, a control valve) that can be signaled by a controller to selectively open and close. In an exemplary embodiment, a controller is configured to pulse the valve open and closed to periodically break the stream being output from the valve. For example, the valve can be operated to repeatedly conduct an open/closed duty cycle consisting of an open stage and a subsequent closed stage. In one or more embodiments the open stage is longer than the closed stage. For example, the open stage can be 80% of the open/closed duty cycle in one illustrative example.

Accordingly, the metered stream of waste SW can be a continuous stream, a stream comprised of periodic drops of the uncured waste resin, or combinations of the two. In one or more embodiments, the metered discharge valve 106 is configured to output a stream of waste resin through an outlet orifice having an inner diameter (broadly, an inner dimension) in an inclusive range of from 1/16 inch to ½ inch. The size of the outlet orifice corresponds to the cross-sectional dimension of the metered waste stream SW, and in turn, the size of the droplets DW. Depending on the color of the resin being cured, a larger or smaller outlet orifice may be desirable. For clear or white resins, a larger orifice can be used to produce relatively large droplets because UV light will transmit through the resin relatively easily. For dark, opaque resins, a smaller orifice can be used to produce smaller droplets DW that will fully cure despite the opacity of the resin to UV light.

The curing container 108 has an open top end, a closed bottom end, and a side wall extending upward from the closed bottom end to the open top end. The open top end of the curing container 108 is configured so that the metered waste stream SW is passable through the open top end into the curing container. At least one wall of the curing container 108 is formed from UV-transparent material. Preferably, the entire curing container 108 is formed from UV transparent material.

The curing container is configured to hold a surfactant fluid F configured for dispersing the uncured waste stream SW as droplets DW of uncured waste resin. The surfactant fluid F is further configured so that the droplets DW gradually sink to the bottom of the container 108 in the surfactant fluid. For example, in an exemplary embodiment, the curing device 100 is configured so that the waste droplets DW sink along a column of surfactant fluid F that is at least 6 inches tall. In one or more embodiments, the surfactant fluid mixture F comprises a mixture of water and surfactant soap (e.g., dish soap). The inventors found that a surfactant fluid formulated at a ratio 1 part to 1000 parts dish soap-to-water was suitable for the application, but any suitable surfactant fluid can be used without departing from the scope of the disclosure.

In the illustrated embodiment, the curing container 108 includes a removable pellet filter 132 (e.g., a net) that lines at least a lower portion of the container (e.g., the pellet filter can line the entire interior of the container). The pellet filter 132 is configured to filter cured resin pellets PW from the surfactant fluid F when curing is complete. For example, the container 108 is configured so that the cured pellets PW form a pile contained in the pellet filter 132. At the end of a waste curing process, the pellet filter 132 can be lifted out of the container 108 to remove the cured pellets PW from the container 108 while leaving most of the surfactant fluid in the container for reuse.

The curing system 110 is broadly configured to cure the droplets DW as they sink to the bottom of the curing container 108. For example, in one or more embodiments, the curing system 110 is configured to fully cure the droplets DW so that the waste lands on the bottom of the container 108 in the form of fully cured resin pellets PW. The curing system 110 generally comprises at least one UV light 140. In the illustrated embodiment, the curing system 100 comprises a plurality of UV lights 140 spaced apart about the perimeter of the curing chamber 116. For example, there may be one UV light fixture 140 at each corner of the curing chamber that points toward the curing container 108. In an exemplary embodiment, the UV lights 140 emit light having a wavelength in an inclusive range of from 365 nm to 435 nm. The inventors believe that wavelengths closer to 405 nm might be preferred. In the illustrated embodiment, the light fixtures 140 are 40 W UV lights that emit light at a wavelength of about 395 nm. Those skilled in the art will recognize that this type of light fixture is widely available. In an exemplary embodiment, the curing system 110 further comprises UV reflective surfaces 142 (e.g., mirrors) on the interior walls of the curing chamber 116. Together, the UV lights 140 and UV reflective surfaces 142 impart enough UV light into the container 108 through the transparent container walls to cure the droplets DW as they sink to the bottom of the container.

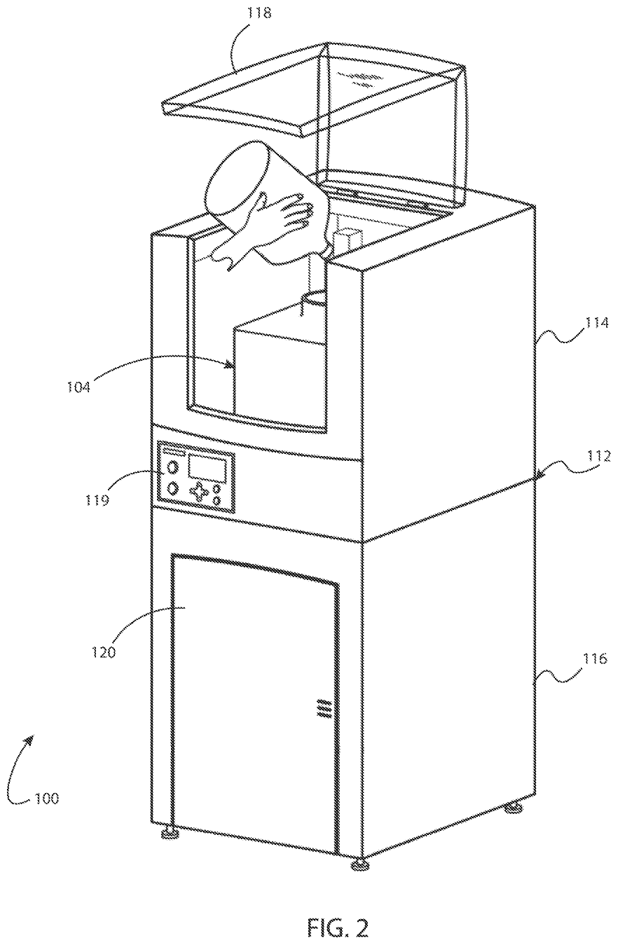

Having described the waste curing device 100, an exemplary process for using the waste curing device to remediate the uncured waste resin byproduct of 3D printing will now be briefly described. Initially, a manufacturer collects a quantity of uncured 3D printing waste resin produced as the byproduct of normal 3D printing operations. When a desired quantity of uncured waste resin UW is collected, as shown in FIG. 2, the manufacturer opens the hopper chamber access door 118, removes the lid 130 from the hopper 104, and pours the uncured waste resin UW into the hopper through the inlet opening at the top of the hopper. Then the manufacturer secures the lid 130 to the hopper 104 and closes the access door 118. At this time, the metered discharge valve 106 is closed, the curing system 110 is off, the pellet filter 132 is installed in the curing container 108, the curing container 108 is holding surfactant fluid F, and the curing chamber access door 120 is closed. The curing container 108 is not completely filled with surfactant fluid F to provide capacity for the volume of the resin that will be imparted into the curing container during the process. For example, in one or more embodiments, the curing container is filled to about half full of surfactant fluid at the beginning of the process.

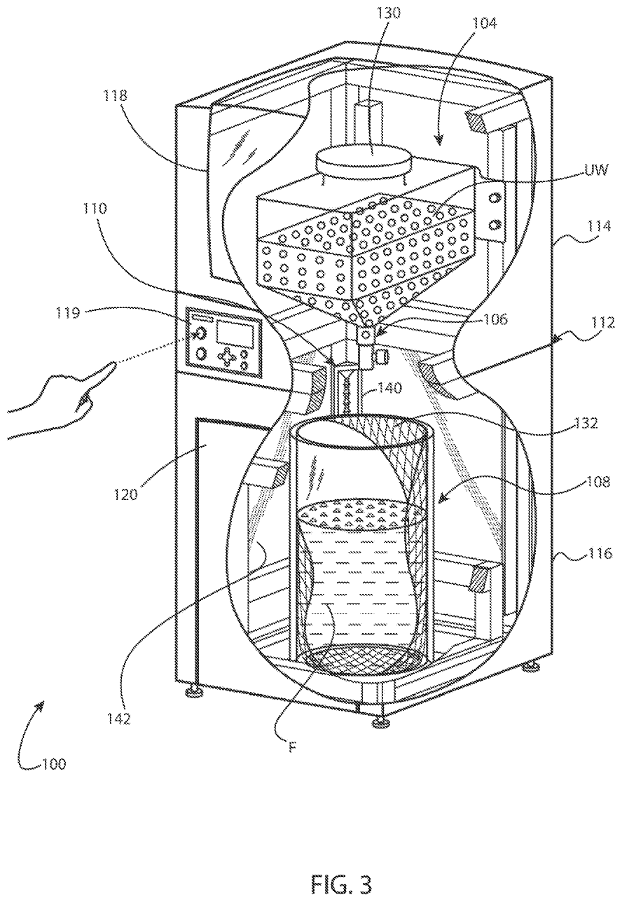

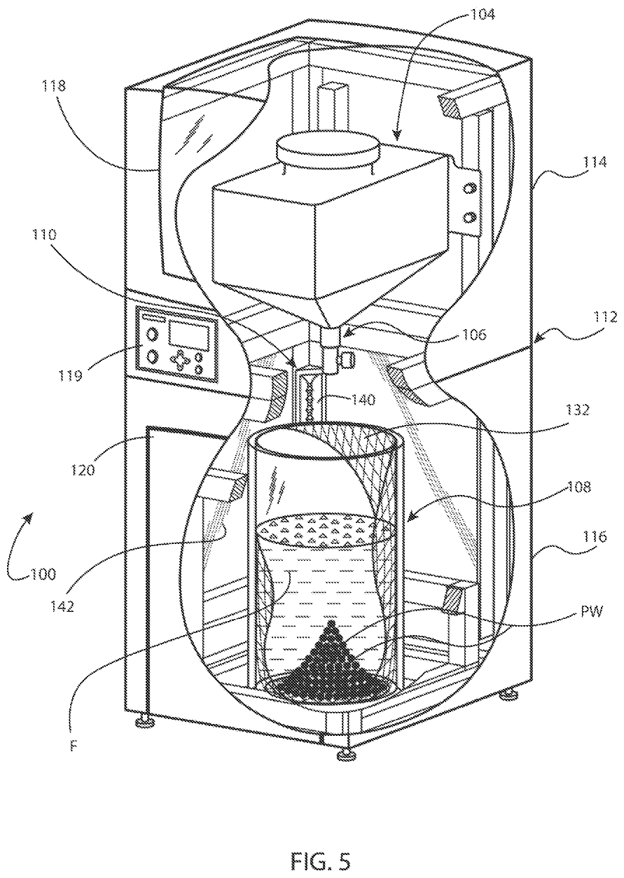

To start the curing process, the user presses an activation input on the control panel 119, as shown in FIG. 3. A device controller (not shown) then automatically opens the metered discharge valve 106 to output a metered waste stream SW into the curing container 108, as shown in FIG. 4. At the same time, the controller activates the UV lights 140. The surfactant fluid F disperses the waste resin as discrete droplets DW, and the droplets gradually sink to the bottom of the container 108. As the droplets DW sink, the UV light from the light fixtures 140 fully cures the waste into cured resin pellets PW. The pellets PW form a pile on the bottom of the container 108, and the pile is contained in the pellet filter 132, as shown in FIG. 5. The process continues until all the uncured waste resin UW drains from the hopper 104 and cures into pellets PW.

When a curing cycle is complete, the curing chamber access door 120 is opened, and the container 108 is taken out of the curing chamber 116 (see FIGS. 6 and 7). Subsequently, the pellet filter 132 is lifted out of the container 108 to remove the fully cured pellets PW while preserving the surfactant fluid for use in another curing process. The fully cured pellets PW are safe to dispose of as normal, non-hazardous trash. Alternatively, the cured pellets PW could be recycled for use in another manufacturing process or used directly as a pelletized cured resin product.

It can now be seen that the waste curing device 100 provides a save method to dispose of the hazardous uncured waste byproduct of certain 3D manufacturing processes. It is envisioned that the curing device 100 could be sized for use in a 3D printing facility to provide 3D printers with an in-house solution for hazardous waste disposal. For example, in one or more embodiments the device 100 has a footprint less than or equal to 20 inches by 20 inches. It is also envisioned that the device could be sized for industrial-scale disposal of this type of 3D printing waste byproduct. Regardless of form factor, the device 100 takes in collected hazardous, uncured waste resin and outputs safe, easy-to-handle, fully cured, and potentially usable pelletized resin.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A waste curing device for curing uncured waste resin from a manufacturing process, the was curing device comprising:
a waste hopper adapted to receive the uncured waste resin;
a metered discharge valve connected to the waste hopper to receive the uncured waste resin and to output a metered stream of waste resin;
a curing container configured to hold surfactant fluid and to receive the metered stream of waste resin into the surfactant fluid such that the surfactant fluid disperses the stream of waste resin as discrete droplets of waste resin; and
a curing system configured to cure the droplets of waste in the curing container to form cured waste pellets.

2. The waste curing device of claim 1, wherein the metered discharge valve is configured to output through an orifice having an inner dimension in an inclusive range of from 1/16 inch to ½ inch.

3. The waste curing device of claim 1, wherein the curing container is configured to hold the surfactant fluid such that the surfactant fluid forms a fluid column having a height along which the discrete droplets of water sink, the height being at least 6 inches.

4. The waste curing device of claim 1, wherein the waste curing device is configured so that the droplets sink in the curing container.

5. The waste curing device of claim 4, wherein the curing system is configured to cure the droplets as the droplets sink in the curing container.

6. The waste curing device of claim 5, wherein the curing container has a bottom and is configured to collect the cured waste pellets in a pile on the bottom of the curing container.

7. The waste curing device of claim 1, wherein the curing system comprises one or more UV lights and the curing container includes at least one wall formed from UV-transparent material.

8. The waste curing device of claim 7, further comprising a curing chamber, the curing container and the one or more UV lights being received in the curing chamber, the curing chamber having one or more UV-reflective internal surfaces.

9. The waste curing device of claim 8, wherein the curing chamber has a plurality of walls that meet at corners and wherein the one or more UV lights comprises a UV light positioned at each corner of the curing chamber.

10. The waste curing device of claim 1, wherein the waste curing device further comprises a pellet filter in the curing container configured to filter the cured pellets from the surfactant fluid.

11. The waste curing device of claim 10, wherein the pellet filter is configured to be lifted out of the waste curing device whereby the pellet filter removes the cured pellets from the curing container and the surfactant fluid.

12. A method of disposing of uncured waste resin from a manufacturing process, the method comprising:
dispersing droplets of the uncured waste resin in a curing container; and
curing the droplets of waste resin in the curing container to form cured pellets.

13. The method of claim 12, wherein said curing comprises curing the droplets as the droplets sink in surfactant fluid contained in the curing container.

14. The method of claim 12, further comprises imparting a metered stream of the uncured waste resin into the curing container.

15. The method of claim 14, wherein said dispersing comprises contacting the metered stream with surfactant fluid in the curing container.

16. A method of disposing of uncured waste resin from a 3D printing process, the method comprising:
collecting the uncured waste resin at a site of one or more 3D printers used in the 3D printing process; and
curing the collected uncured waste resin into pellets at the site.
